(19) United States
(12) Patent Application Publication
(10) Pub. No.: US 2015/0267911 A1
(43) Pub. Date: Sep. 24, 2015

(54) Illuminating Rain Poncho

(71) Applicant: Quinn A. Cushnie, Cambridge Springs, PA (US)

(72) Inventor: Quinn A. Cushnie, Cambridge Springs, PA (US)

(21) Appl. No.: 14/665,155

(22) Filed: Mar. 23, 2015

Related U.S. Application Data
(60) Provisional application No. 61/968,534, filed on Mar. 21, 2014.

(51) Int. Cl. F21V 33/00; F21V 23/04; A41D 3/08; F21L 4/08; F21V 31/00; F21V 7/00; F21V 23/00; F21V 8/00

(52) U.S. Cl. CPC F21V 33/0008; F21V 23/009; F21V 23/0414; G02B 6/0008; F21L 4/08; F21V 31/005; F21V 7/0075; A41D 3/08; F21W 2111/10

(57) ABSTRACT

An illuminating poncho provides the wearer with protection from weather elements as well as illumination. The illumination poncho includes a transparent poncho, a portable power source, a microcontroller, a plurality of light emitters, a plurality of diffusers, and a housing. The portable power source provides electric energy to the microcontroller. The microcontroller is electronically connected to the plurality of light emitters and thus controls their behavior. The plurality of light emitters is optically coupled to the plurality of diffusers. The plurality of diffusers is distributed about the torso portion of the transparent poncho, therefore illuminating various regions accordingly. The microcontroller, the plurality of light emitters, and the portable power source are mounted within the housing. The housing is integrated into the torso portion through a sealable pouch.

The current application claims a priority to the U.S. Provisional Patent application Ser. No. 61/968,534 filed on Mar. 21, 2014. The current application is filed on Mar. 23, 2015 while Mar. 21, 2014 was on a weekend.

### FIELD OF THE INVENTION

The present invention relates generally to rainwear apparel. More specifically, the present invention is an illuminating poncho that provides protection from the elements as well as illumination for the wearer in the form of light-emitting diodes (LEDs) embedded within the raincoat. The behavior of the LEDs is regulated by a microcontroller integrated with the raincoat. The LEDs are positioned within the raincoat to complement a visual design present on the exterior of the raincoat.

### BACKGROUND OF THE INVENTION

A commonly worn article of clothing for protection from the elements is a raincoat. Raincoats are commonly composed of material that is both waterproof and breathable for simultaneous protection from the elements and wearer comfort. Raincoats may be worn to stay dry during particularly heavy precipitation when the wearer does not wish to become wet or ruin his or her clothing. Additionally, raincoats may be more convenient for those who do not wish to carry and use an umbrella. In its basic form, a raincoat generally comprises an article of clothing that is designed to be worn over the torso and often a portion of the legs. Based on the style of raincoat, the raincoat may comprise a left sleeve and a right sleeve or a left arm opening and a right arm opening (for example, a poncho). Raincoats generally comprise a hood as well for covering the head. A raincoat's material allows water to come into contact with the raincoat and slide off without coming into contact with the wearer or the wearer's clothing worn below the raincoat. The present invention enhances and improves upon conventional raincoats and similar rainwear apparel through the integration of a unique illumination system and a plurality of reflective strips. The illumination system is integrated into the thickness of the present invention and provides functional and aesthetic illumination.

### BRIEF DESCRIPTION OF THE DRAWINGS

FIG. 1 is a perspective view of the present invention.

FIG. 2 is a right-side view of the present invention.

FIG. 3 is a schematic diagram of the electronic components of the present invention.

FIG. 4 is a perspective view of the present invention depicting a specific visual design.

### DETAIL DESCRIPTIONS OF THE INVENTION

All illustrations of the drawings are for the purpose of describing selected versions of the present invention and are not intended to limit the scope of the present invention.

The present invention is an illuminating poncho that provides a wearer with protection from the elements as well as illumination. Additionally, the present invention incorporates a multitude of reflective strips distributed about the body of the poncho to further increase the safety of the wearer.

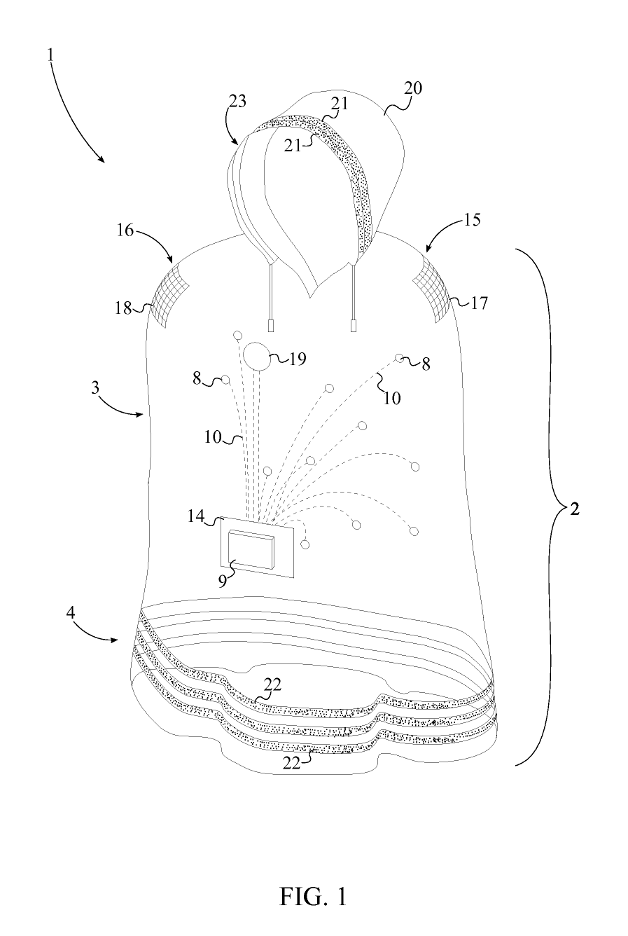

Referring to FIG. 1-3, the present invention comprises a transparent poncho 1, a portable power source 5, a microcontroller 6, a plurality of light emitters 7, a plurality of light diffusers 8, and a housing 9. The transparent poncho 1 provides the wearer protection from the elements and comprises a torso portion 2. The portable power source 5 supplies electric energy to the various electrical components of the present invention. More specifically, the portable power source 5 is electrically connected to the microcontroller 6. The microcontroller 6 is in turn electronically connected to each of the plurality of light emitters 7. The microcontroller 6 controls the flow of electricity to the plurality of light emitters 7. The plurality of light emitters 7 is optically coupled to the plurality of light diffusers 8 to transmit the light produced by the plurality of light emitters 7 to the various locations of the plurality of light diffusers 8. The preferred light emitter is a light emitting diode (LED), although alternative devices may be utilized instead. Different types, colors, and sizes of LEDs may be utilized. The plurality of light diffusers 8 is distributed about the torso portion 2 and is a means for scattering or diffusing light produces by the plurality of light emitters 7. The plurality of light diffusers 8 increases the illumination area of the plurality of light emitters 7. The microcontroller 6, the plurality of light emitters 7, and the portable power source 5 are mounted within the housing 9 to ensure adequate protection to the delicate electronic components. The housing 9 is in turn integrated into the transparent poncho 1 as seen in FIG. 1. In general, the microcontroller 6 manipulates the electric energy from the portable power source 5 in order to power the plurality of light emitters 7 and produce light. Said light is then diffused about various regions of the torso portion 2 by the plurality of light diffusers 8. It is preferred that a visual design is integrated into the exterior surface of the transparent poncho 1. It is also preferred that the plurality of light diffusers 8 be positioned about the torso portion 2 such that various regions of the visual design are illuminated to increase and/or modify the aesthetic appeal of the visual design and in turn the transparent poncho 1.

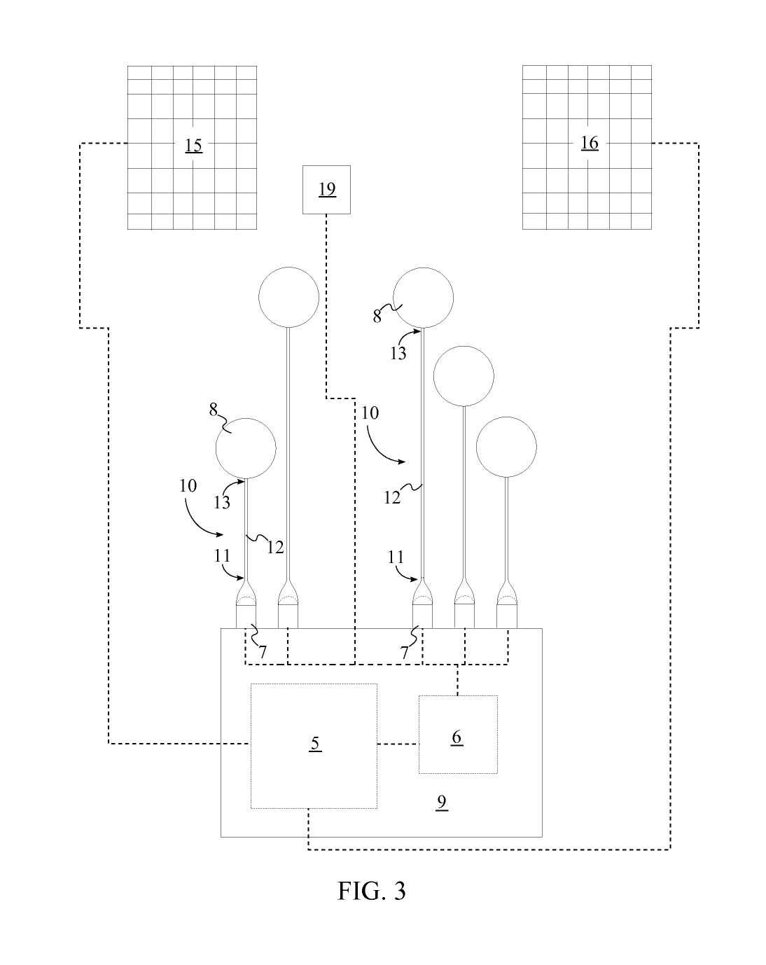

The plurality of light emitters 7 is optically coupled to the plurality of light diffusers 8 as seen in FIG. 3, more specifically through the use of a plurality of fiber optic strands 10. Each of the plurality of fiber optic strands 10 comprises a first end 11, a strand body 12, and a second end 13. The first end 11 of each of the plurality of fiber optic strands 10 is optically coupled to the plurality of light emitters 7, preferably through the use of a heat shrink process and a bonding agent; alternative coupling methods may also be used instead. The second end 13 for each of the plurality of fiber optic strands 10 is optically coupled to a corresponding diffuser from the plurality of light diffusers 8. Various types of light diffusers may be utilized for the present invention including, but not limited to, ground glass diffusers, teflon diffusers, opal glass diffusers, greyed glass diffusers, and other similar devices and translucent objects. The strand body 12 uses total internal reflection to acts as a waveguide for the light produced by the plurality of light emitters 7. The strand body 12 is located in between the first end 11 and the second end 13 and thus allows for the transmission of light from the first end 11 to the second end 13. The strand body 12 is mounted into the torso portion 2, preferably integrated into the thickness of the torso portion 2 such that the strand body 12 is flush with the external surface and the internal surface of the torso portion 2.

In one embodiment, the each of the plurality of fiber optic strands 10 is optically coupled to a corresponding light emitter from the plurality of light emitters 7. This embodiment allows for each diffuser from the plurality of light diffusers 8 to be customized in respect to the color being diffused. In an alternative embodiment, more than one first end 11 from the plurality of fiber optic strands 10 may be coupled to a single corresponding light emitter from the plurality of light emitters 7. This embodiment is a more energy saving approach that still allows for partial customization to the color selection. In yet another embodiment, the first end 11 of all of the plurality of fiber optic strands 10 is optically coupled to a single corresponding light emitter from the plurality of light emitters 7. This configuration is the most optimal design in terms of energy conservation. Furthermore, alternative configurations may also be utilized. Each of the plurality of light emitters 7 is preferably a light emitting diode, although alternative light sources may be utilized instead or in addition to.

The behavior of the plurality of light emitters 7 is controlled by the microcontroller 6. The microcontroller 6 is programmed to regulate the flow of electric energy to the plurality of light emitters 7 and thus regulating the behavior of the plurality of light emitters 7. The microcontroller 6 may cause the plurality of light emitters 7 to pulse and fade at various rates and patterns. Alternatively, the plurality of light emitters 7 may remain on without interruptions when active. The microcontroller 6 may be able to execute various different programs for controlling the plurality of light emitters 7. A button switch 19 is used to activate the microcontroller 6. The button switch 19 is mounted into the torso portion 2 and is electronically connected to the microcontroller 6. The button switch 19 is preferably positioned on a chest region 3 of the torso portion 2 such that the wearer may easily and quickly activate and deactivate the plurality of light emitters 7. In one embodiment of the present invention, a light modification control panel is used either in addition to or instead of the button switch 19. Similar to the button switch 19, the light modification control panel is mounted into the torso portion 2 and is electronically connected to the microcontroller 6. The light modification control panel allows the wearer to choose between different programs installed on the microcontroller 6 which control the behavior of the plurality of light emitters 7.

Referring to FIG. 1, the housing 9 is more specifically integrated into the torso portion 2 through the use of a sealable pouch 14. The sealable pouch 14 is a pocket or a similar receptacle that may be closed and opened with little effort. The sealable pouch 14 is integrated into the torso portion 2, preferably facing the interior surface of the torso portion 2. The housing 9 is positioned within the sealable pouch 14, allowing the wearer to easily access the housing 9 for maintenance purposes. Through the use of the sealable pouch 14 the wearer can easily recharge or replace the portable power source 5 when the charge is low. Additionally, other components may be repaired or switched out through this design. In one embodiment, the portable power source 5 is a rechargeable power source and is recharged by a first solar panel 17 and a second solar panel 18. The transparent poncho 1 further comprises a left shoulder portion 15 and a right shoulder portion 16. The first solar panel 17 is externally mounted onto the left shoulder portion 15 as seen in FIG. 1. Similarly, the second solar panel 18 is externally mounted onto the right shoulder portion 16 as seen in FIG. 1. The first solar panel 17 and the second solar panel 18 are electrically connected to the rechargeable power source; and convert light energy form the sun to electric energy to recharge said portable power source 5.

Referring to FIG. 1, the transparent poncho 1 further comprises a hood 20. In alternative embodiments, the transparent poncho 1 may also include sleeves for the arms of the wearer, pockets, zippers, buttons, and any other similar features utilized on modern rain gear. The hood 20 is integrated into the torso portion 2 and provides protection for the wearer's head. The transparent poncho 1 may be composed of a material that is impervious to fluid and translucent to allow for the transmission of light. The preferred material is translucent polyvinyl chloride (PVC), although alternative materials may also be utilized.

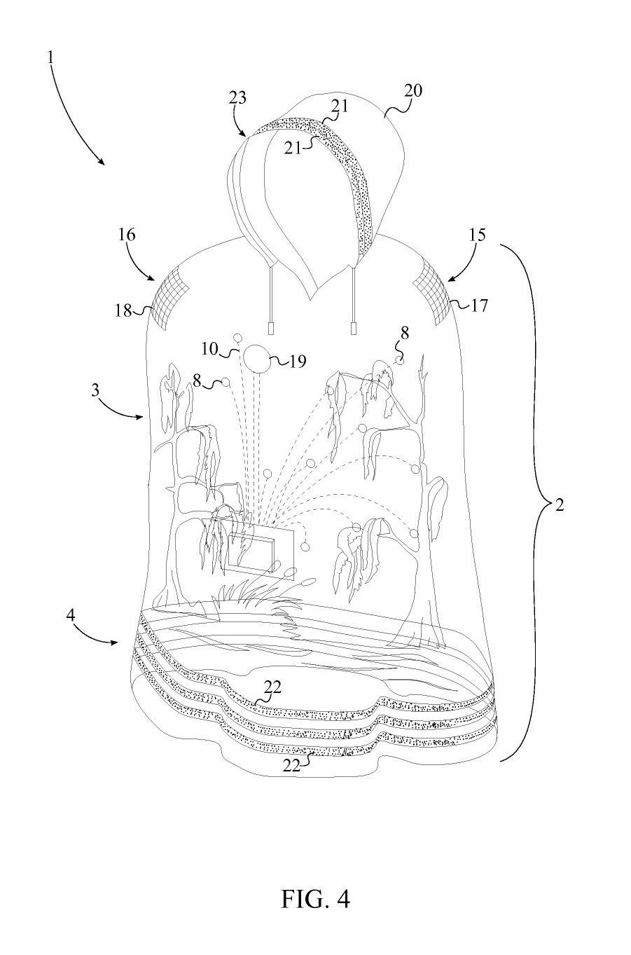

The present invention is not limited with respect to the specific visual design depicted on the exterior surface of the transparent poncho 1. In the preferred embodiment of the present invention, the visual design is present on the front side of the torso portion 2. Examples of visual designs include, but are not limited to, scenery and logos of sports teams. For example, the visual design may be appealing to girls or boys. For girls, the visual design may include, but is not limited to, stars and night sky on a horizon, a sunrise on a horizon, girl on tree swing under stars, scenes with rainbows, planets, fireworks, different firefly scenes, states, unicorns, fairies and aquatic scenes. For boys, the visual design may include, but is not limited to, horses, police cars or fire engines, day or night horizons, auroras, dragons, flashlight scenes, different firefly scenes, planets, cars, fireworks, scenes with wolves or animals with glowing eyes, other bio-luminescent creatures like bathypalegic zone deep sea, light house by sea, boy on tree swing under stars, scenes of the universe, solar systems, black holes, nebulae, ghosts and ominous castle scenes. Furthermore, unisex visual designs may be utilized to cater to a larger array of preferences. An example of a visual design is depicted in FIG. 4.

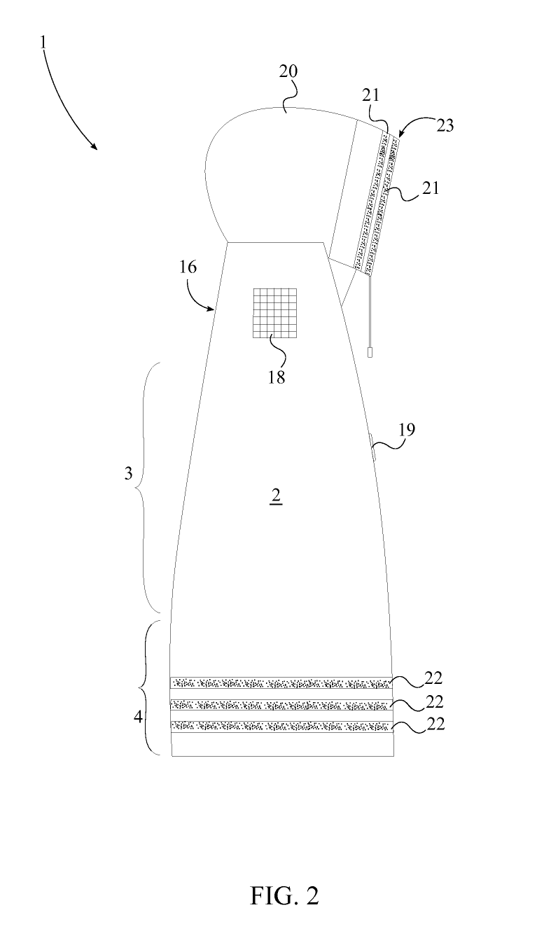

In one embodiment, to further increase the visibility of the wearer in darkened conditions, the present invention includes an at least one hood reflective strip 21 and an at least one waist reflective strip 22. The at least one hood reflective strip 21 is externally connected about a rim 23 of the hood 20 as seen in FIG. 1 and FIG. 2. The at least one waist reflective strip 22 is externally connected about a waist region 4 of the torso portion 2 as seen in FIG. 1 and FIG. 2. The at least one hood reflective strip 21 and the at least one waist reflective strip 22 may vary in length, design, pattern, and material composition to suit the needs of the wearer.

In one embodiment, the electronic and lighting components of the transparent poncho 1 are all contained within the interior of the transparent poncho 1. Additionally, the button switch 19, the plurality of light emitters 7, the electric wiring, and the plurality of fiber optic strands 10 are protected by a layer of sheeting. The layer of sheeting serves as a secondary layer that is only present along interior regions of the transparent poncho 1 that correspond to the positioning of the interior components. The interior layer of sheeting may be heat fused or vacuum sealed in order to provide protection to the interior components.

Although the invention has been explained in relation to its preferred embodiment, it is to be understood that many other possible modifications and variations can be made without departing from the spirit and scope of the invention as hereinafter claimed.

What is claimed is:

1. An illuminating poncho comprises:
a transparent poncho;
a portable power source;
a microcontroller;
a plurality of light emitters;
a plurality of light diffusers;
a housing;
the transparent poncho comprises a torso portion;
the microcontroller, the plurality of light emitters, and the portable power source being mounted within the housing;
the portable power source being electrically connected to the microcontroller;
the microcontroller being electronically connected to each of the plurality of light emitters;
the housing being integrated into the transparent poncho;
the plurality of light emitters being optically coupled to the plurality of light diffusers; and
the plurality of light diffusers being distributed about the torso portion.

2. The illuminating poncho as claimed in claim 1 comprises:
a plurality of fiber optic strands;
each of the plurality of fiber optic strands comprises a first end and a second end;
the first end for each of the plurality of fiber optic strands being optically coupled to the plurality of light emitters; and
the second end for each of the plurality of fiber optic strands being optically coupled to a corresponding diffuser from the plurality of light diffusers.

3. The illuminating poncho as claimed in claim 2 comprises:
each of plurality of fiber optic strands further comprises a strand body;
the strand body being located between the first end and the second end; and
the strand body being mounted into the torso portion.

4. The illuminating poncho as claimed in claim 1 comprises:
a sealable pouch;
the sealable pouch being integrated into the torso portion; and
the housing being positioned within the sealable pouch.

5. The illuminating poncho as claimed in claim 1 comprises:
the portable power source being a rechargeable power source;
the transparent poncho further comprises a left shoulder portion and a right shoulder portion;
a first solar panel;
a second solar panel;
the first solar panel being externally mounted onto the left shoulder portion;
the second solar panel being externally mounted onto the right shoulder portion; and
the left shoulder portion and the right shoulder portion being electrically connected to the rechargeable power source.

6. The illuminating poncho as claimed in claim 1 comprises:
a button switch;
the button switch being mounted into the torso portion; and
the button switch being electronically connected to the microcontroller.

7. The illuminating poncho as claimed in claim 6 comprises:
the button switch being positioned on a chest region of the torso portion.

8. The illuminating poncho as claimed in claim 1 comprises:
the transparent poncho further comprises a hood;
an at least one hood reflective strip; and
the at least one hood reflective strip being externally connected about a rim of the hood.

9. The illuminating poncho as claimed in claim 1 comprises:
an at least one waist reflective strip; and
the at least one waist reflective strip being externally connected about a waist region of the torso portion.

10. An illuminating poncho comprises:
a transparent poncho;
a portable power source;
a microcontroller;
a plurality of light emitters;
a plurality of light diffusers;
a housing;
a plurality of fiber optic strands;
the transparent poncho comprises a torso portion;
each of the plurality of fiber optic strands comprises a first end and a second end;
the microcontroller, the plurality of light emitters, and the portable power source being mounted within the housing;
the portable power source being electrically connected to the microcontroller;
the microcontroller being electronically connected to each of the plurality of light emitters;
the housing being integrated into the transparent poncho;
the plurality of light emitters being optically coupled to the plurality of light diffusers;
the plurality of light diffusers being distributed about the torso portion;
the first end for each of the plurality of fiber optic strands being optically coupled to the plurality of light emitters; and
the second end for each of the plurality of fiber optic strands being optically coupled to a corresponding diffuser from the plurality of light diffusers.

11. The illuminating poncho as claimed in claim 10 comprises:
each of plurality of fiber optic strands further comprises a strand body;
the strand body being located between the first end and the second end; and
the strand body being mounted into the torso portion.

12. The illuminating poncho as claimed in claim 10 comprises:
a sealable pouch;
the sealable pouch being integrated into the torso portion; and
the housing being positioned within the sealable pouch.

13. The illuminating poncho as claimed in claim 10 comprises:
the portable power source being a rechargeable power source;
the transparent poncho further comprises a left shoulder portion and a right shoulder portion;
a first solar panel;
a second solar panel;
the first solar panel being externally mounted onto the left shoulder portion;
the second solar panel being externally mounted onto the right shoulder portion; and
the left shoulder portion and the right shoulder portion being electrically connected to the rechargeable power source.

14. The illuminating poncho as claimed in claim 10 comprises:
a button switch;
the button switch being mounted into the torso portion;
the button switch being electronically connected to the microcontroller; and
the button switch being positioned on a chest region of the torso portion.

15. The illuminating poncho as claimed in claim 10 comprises:
the transparent poncho further comprises a hood;
an at least one hood reflective strip;
an at least one waist reflective strip;
the at least one hood reflective strip being externally connected about a rim of the hood; and
the at least one waist reflective strip being externally connected about a waist region of the torso portion.

16. An illuminating poncho comprises:
a transparent poncho;
a portable power source;
a microcontroller;
a plurality of light emitters;
a plurality of light diffusers;
a housing;
a first solar panel;
a second solar panel;
the transparent poncho comprises a torso portion, a left shoulder portion, a right shoulder portion;
the microcontroller, the plurality of light emitters, and the portable power source being mounted within the housing;
the portable power source being electrically connected to the microcontroller;
the microcontroller being electronically connected to each of the plurality of light emitters;
the housing being integrated into the transparent poncho;
the plurality of light emitters being optically coupled to the plurality of light diffusers;
the plurality of light diffusers being distributed about the torso portion;
the portable power source being a rechargeable power source;
the first solar panel being externally mounted onto the left shoulder portion;
the second solar panel being externally mounted onto the right shoulder portion; and
the left shoulder portion and the right shoulder portion being electrically connected to the rechargeable power source.

17. The illuminating poncho as claimed in claim 16 comprises:
a plurality of fiber optic strands;
each of the plurality of fiber optic strands comprises a first end, a strand body, a second end;
the first end for each of the plurality of fiber optic strands being optically coupled to the plurality of light emitters;
the second end for each of the plurality of fiber optic strands being optically coupled to a corresponding diffuser from the plurality of light diffusers;
the strand body being located between the first end and the second end; and
the strand body being mounted into the torso portion.

18. The illuminating poncho as claimed in claim 16 comprises:
a sealable pouch;
the sealable pouch being integrated into the torso portion; and
the housing being positioned within the sealable pouch.

19. The illuminating poncho as claimed in claim 16 comprises:
a button switch;
the button switch being mounted into the torso portion;
the button switch being electronically connected to the microcontroller; and
the button switch being positioned on a chest region of the torso portion.

20. The illuminating poncho as claimed in claim 16 comprises:
the transparent poncho further comprises a hood;
an at least one hood reflective strip;
an at least one waist reflective strip;
the at least one hood reflective strip being externally connected about a rim of the hood; and
the at least one waist reflective strip being externally connected about a waist region of the torso portion.
